(19) United States
(12) Patent Application Publication
(10) Pub. No.: US 2025/0068934 A1
(43) Pub. Date: Feb. 27, 2025

(54) OPTIMIZING PARALLEL PROCESSING OF DECISION TREE INFERENCES

(71) Applicant: International Business Machines Corporation, Armonk, NY (US)

(72) Inventors: Jan Van Lunteren, RUESCHLIKON (CH); Nikolaos Papandreou, Thalwil (CH); Charalampos Pozidis, Thalwil (CH)

(21) Appl. No.: 18/454,848

(22) Filed: Aug. 24, 2023

(51) Int. Cl. G06N 5/01; G06F 17/16

(52) U.S. Cl. CPC G06N 5/01; G06F 17/16

(57) ABSTRACT

A system may receive a request to perform machine learning inferences, the request including a specification, according to which the machine learning inferences are to be performed on K input records based on N decision trees. The system may determine, based on the specification and a configuration of a computerized system, an optimal number k of the K input records and an optimal number n of the N decision trees to be processed in parallel by the system for performing the machine learning inferences, where 1≤k≤K and 1≤n≤N. The system may perform the machine learning inferences by executing parallel operations, whereby up to k input records and up to n decision trees are repeatedly processed in parallel by the system, to obtain inferences for each of the K input records based on the N decision trees.

### BACKGROUND

The present disclosure relates to the field of machine learning, and more particularly to performing machine learning inferences based on decision trees.

Decision tree learning is a predictive modelling approach used in machine learning. It relies on one or more decision trees, forming the predictive model. Decision trees are widely used machine learning algorithms, owing to their simplicity and interpretability. Different types of decision trees are known, including classification trees and regression trees. A binary decision tree is basically a structure involving coupled decision processes. Starting from the root, a feature is evaluated, and one of the two branches of the root node is selected. This procedure is repeated until a leaf node is reached, a value of which is used to assemble a final result.

### SUMMARY

In some aspects, the techniques described herein relate to a computer-implemented method of performing machine learning inferences, the computer-implemented method including: receiving a request to perform machine learning inferences, the request including a specification, according to which the machine learning inferences are to be performed on K input records based on N decision trees, where K≥1 and N≥2; determining, based on the specification and a configuration of a computerized system, an optimal number k of the K input records and an optimal number n of the N decision trees to be processed in parallel by this computerized system for performing the machine learning inferences, where 1≤k≤K and 1≤n≤N, and performing the machine learning inferences by executing parallel operations, whereby up to k input records and up to n decision trees are repeatedly processed in parallel by the computerized system, to obtain inferences for each of the K input records based on the N decision trees.

In some aspects, the techniques described herein relate to a system for performing machine learning inferences, the system including: a receiving unit configured to receive a request to perform machine learning inferences, and processing means, which are configured to: process the received request to identify a specification, according to which the machine learning inferences are to be performed on K input records, based on N decision trees, where K≥1 and N≥2; determine, based on the identified specification and a configuration of the processing means, an optimal number k of the K input records and an optimal number n of the N decision trees to be processed in parallel for performing the machine learning inferences, where 1≤k≤K and 1≤n≤N, and perform the machine learning inferences by executing parallel operations, whereby up to k input records and up to n decision trees are repeatedly processed in parallel by the processing means, to obtain inferences for each of the K input records based on the N decision trees.

In some aspects, the techniques described herein relate to a computer program product for performing machine learning inferences, the computer program product including a computer readable storage medium having program instructions embodied therewith, the program instructions executable by processing means of a system to cause the system to: process a received request to perform machine learning inferences, in order to identify a specification, according to which the machine learning inferences are to be performed on K input records, based on N decision trees, where K≥1 and N≥2; determine, based on the specification and a configuration of the processing means, an optimal number k of the K input records and an optimal number n of the N decision trees to be processed in parallel by the processing means for performing the machine learning inferences, where 1≤k≤K and 1≤n≤N, and perform the machine learning inferences by executing parallel operations, whereby up to k input records and up to n decision trees are repeatedly processed in parallel by the system, to obtain inferences for each of the K input records based on the N decision trees.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example fully balanced, binary decision tree, which includes split nodes and leaf nodes, according to embodiments.

FIG. 2 depicts an example selection of split nodes of the decision tree of FIG. 1, together with node attributes (feature identifiers and threshold values), which are used to execute such nodes, according to embodiments.

FIGS. 3A and 3B illustrates an example of how the evaluation of a decision tree (FIG. 3A) can be cast as a series (FIG. 3B) of three matrix multiplication operations interleaved by two element-wise logical operations, according to embodiments.

FIGS. 4A and 4B illustrate an example of how the evaluation of several decision trees and several input records can be turned into matrix operations and logical operations, whereby tensors can be built according to optimal numbers of input records and decision trees, which correspond to batched representations of the operations shown in FIG. 3B, according to embodiments.

FIG. 5 is a diagram illustrating how the tensor operations can be executed through parallel CPU threads, while some matrix operations are offloaded to a hardware accelerator in an interleaved manner, according to embodiments.

FIGS. 6A, 6B, and 7 are further diagrams illustrating how a tensor representation can be decomposed into tensor subsets for parallel processing, according to embodiments.

FIG. 8 depicts a block diagram of an example computing environment, according to embodiments of the present disclosure.

FIG. 9 depicts a flowchart of an example method of performing decision tree inferences, according to embodiments.

FIG. 10 depicts an example circuit diagram of a processor set of a computerized system, where the processor set includes processing cores and an on-chip hardware accelerator shared by the processing cores, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to machine learning inferences based on decision trees, and more particular aspects relate to dynamically determining optimal numbers of input records and/or decision trees to be processed in parallel by a computerized system, based on a configuration thereof, for subsequently performing the machine learning inferences in parallel. While the present disclosure is not necessarily limited to such applications, various aspects of the disclosure may be appreciated through a discussion of various examples using this context.

Random forest and gradient boosting are important machine learning methods, which are based on binary decision trees. In such methods, multiple decision trees are “walked” in parallel until leaf nodes are reached. The results taken from the leaf nodes are then averaged (regression) or used in a majority vote (classification). Such computations can be time and resource consuming, hence a need to accelerating tree-based inference, notably for ensemble models such as random forest and gradient boosting methods.

Several approaches have been proposed to accelerate tree-based inferences, by optimizing hardware and/or algorithmic characteristics. In general, accelerating tree-based inferences is achieved by speeding up either (i) the individual decision tree processing, or (ii) the parallel processing of multiple decision trees. For example, a method has been proposed, which allows decision trees to be executed by way of tensor operations. I.e., the evaluation of a decision tree is cast as a series of three matrix multiplication operations interleaved by two element-wise logical operations. The technique is appealing as it allows decision trees to be executed as a set of tensor operations. However, a direct application of such tensor operations to large numbers of input records and decision trees (as typically involved in ensemble models) will remain computationally costly.

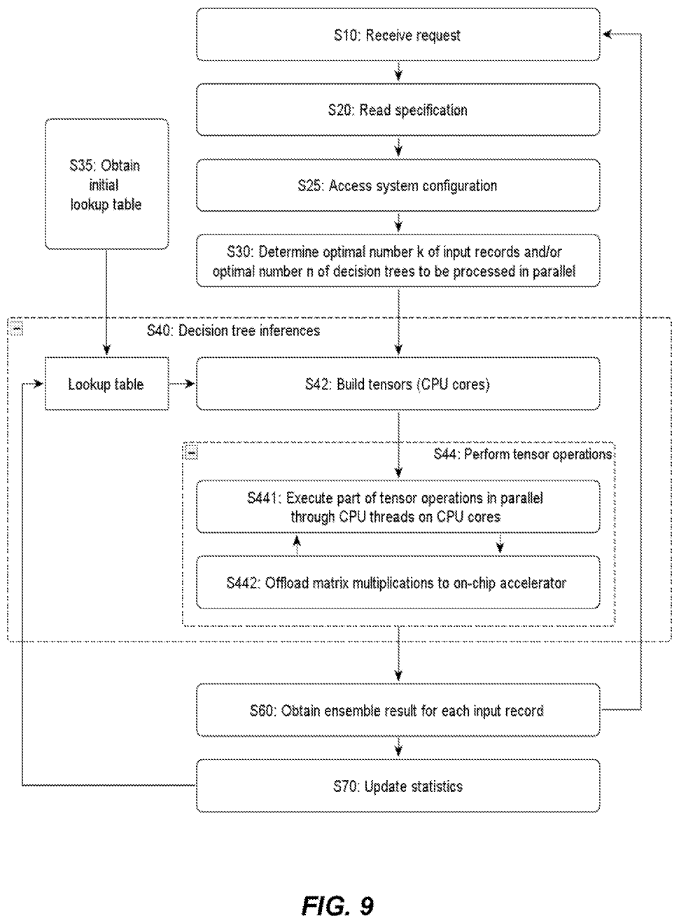

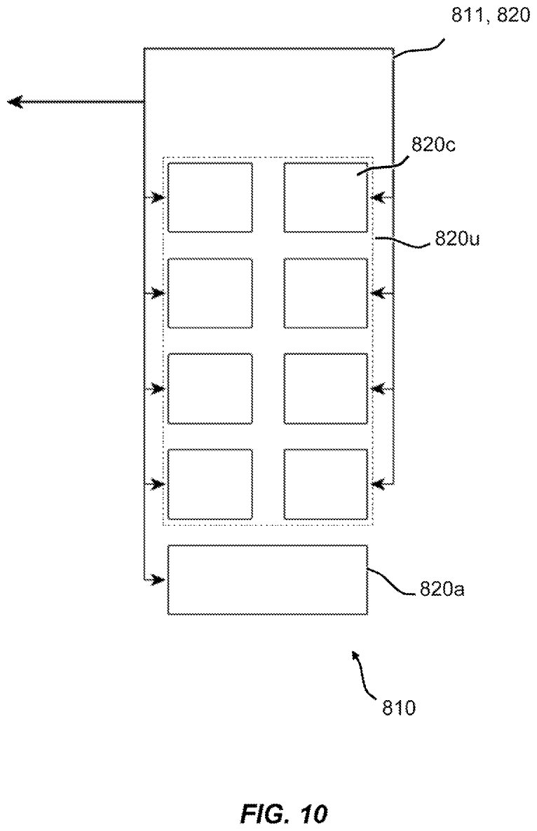

A first aspect of the disclosure is now described in detail, in reference to FIG. 9. This aspect concerns a computer-implemented method of performing machine learning inferences. The method is implemented by a computerized system 800 (or “system” for short) such as shown in FIG. 8, see also FIG. 10. The system 100 concerns another aspect of the disclosure, which is described later in detail.

As seen in the flow of FIG. 9, the method first comprises receiving (step S10 in FIG. 9) a request to perform machine learning inferences. The request may be sent by a client of the system 800. The client can be any entity (a machine, a service, a client program, or a user), connected to the system 800. The request includes a specification, according to which the machine learning inferences are to be performed on K input records based on N decision trees, where K≥1 and N≥2. Note, however, that much larger numbers of input records (100s to 1000s) and decision trees (100s to 10 000s) will typically be involved in practice. For example, the request received may aim at verifying financial transactions, involving, e.g., batches of 1 to 128 input records (i.e., 1≤K≤128), to be processed based thanks to an ensemble model of trees that may involve, e.g., between 100 and 10 000 (or more) trees, i.e., 100≤N≤10 000.

Next, the method comprises determining (step S30) optimal numbers of input records and/or decision trees to be processed in parallel by the computerized system 800 for performing the desired inferences. That is, the method determines S30 one or each of an optimal number k of the K input records and an optimal number n of the N decision trees to be processed in parallel. The optimal numbers are determined based, on the one hand, on the specification (which notably specifies K and N) and, on the other hand, a configuration of a computerized system 800. I.e., the method determine which numbers k and n are optimal for parallel processing, in view of the specification and the system configuration. Depending on the outcome of step S30, k may be any number between 1 and K and, similarly, n may be any number between 1 and N. That is, 1≤k≤K and 1≤n≤N.

Finally, the machine learning inferences are performed (general step S40) by executing S44 parallel operations, whereby up to k input records and/or up to n decision trees are repeatably processed S441, S442 in parallel by the computerized system 800. Note, as per the optimal parameters determined at step S30, the underlying algorithm will strive to process k input records and/or n decision trees in parallel. However, since the overall numbers K and N will not necessarily be integer multiples of k and n, residual operations may eventually be performed, involving k′ input records and/or n′ decision trees, where 1≤k′<k and 1≤n′<1.

The machine learning inferences performed at step S40 eventually cause to obtain S60 inferences for each of the K input records, based on the N decision trees. As evoked above, the N decision trees may typically form part of an ensemble model. In that case, the machine learning inferences are performed to obtain S60 an ensemble result for each of the K input records, as assumed in FIG. 9.

The proposed method amounts to adaptively varying the number of trees and/or inputs that will be repeatably processed in parallel by the computerized system 800, using a dynamic selection algorithm, which takes into account the configuration of the system 800, as well as further parameters, starting with the total number N of trees in the ensemble, and the total number K of input records. Additional parameters may possibly be taken into account, such as the number of split nodes and leaf nodes, as in embodiments discussed below. The proposed approach allows a significant computation speed-up. For example, processing 25trees in parallel allows 18 times faster computations for single record predictions, which is at least three times faster than what prior methods achieve. Additional tests performed by the inventors have shown that the present approach outperforms prior solutions at least for batch sizes up to 128 input records.

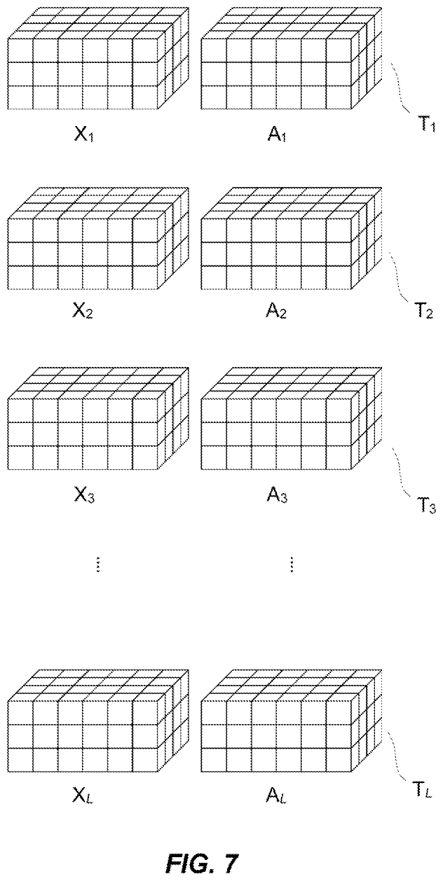

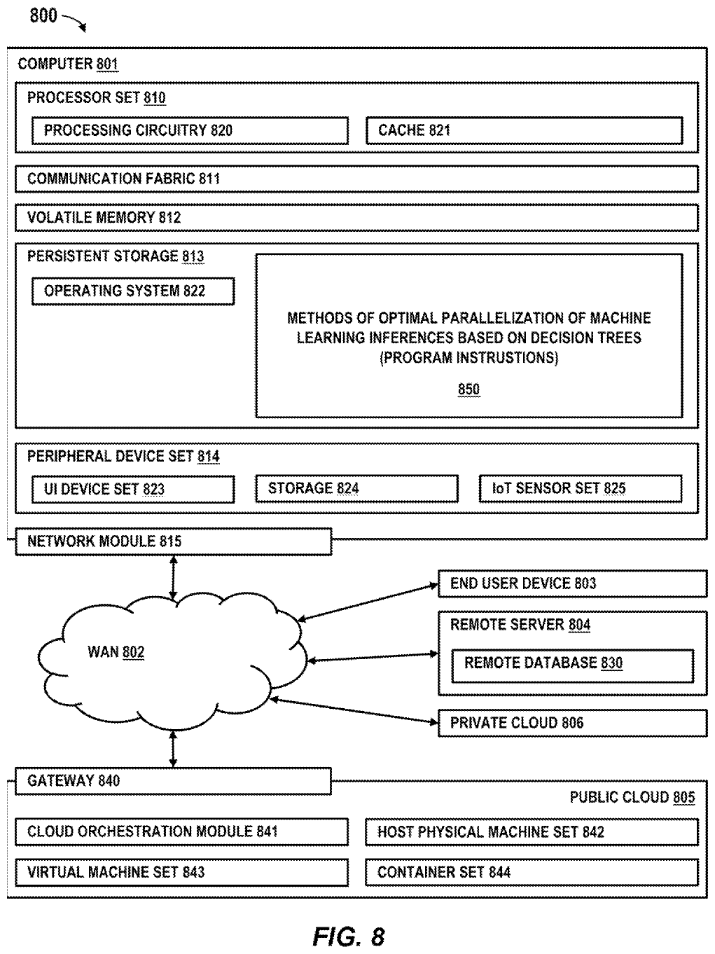

All this is now described in detail, in reference to particular embodiments of the disclosure. To start with, the present methods process decision trees by way of tensor operations, such that tensors (or sets of tensors) are repeatedly processed in parallel. In that respect, the flow of FIG. 9 comprises a step of building S42 sets of tensors T₁-T_{L} corresponding to batched representations of the operands needed to perform the machine learning inferences, as illustrated in FIG. 7. Such tensors are built in accordance with the optimal number k and/or optimal number n of the N decision trees as determined at step S30. Accordingly, the parallel operations executed at step S44 involve parallel executions S441, S442 of tensor operations, which operations are defined in accordance with the tensors T₁-T_{L} built at step S42.

Note, the tensors T₁-T_{L} can be regarded as tensor subsets of a larger tensor. What matters, in the present case, is that such tensors T₁-T_{L} are processed, at least partly, in parallel. The number L of tensors built at step S42 depends on the optimal numbers k and n.

In some embodiments, the processing means 810 of the computerized system 800 includes a central processing unit (CPU) 820u, which includes a given number of CPU cores 820c, e.g., eight cores in the example of FIG. 10. As usual, the cores 820c may allow a number of CPU threads to perform certain tasks. Now, the parallelization performance results may significantly vary, depending on the number of available CPU cores and threads, and the specification of the decision tree inferences to be performed, where this specification notably states the numbers K and N. Thus, it is advantageous to try and find which are the optimal numbers of input records and/or decision trees that can most profitably be processed in parallel by the computerized system 800, so as to optimize the overall computational performance, as the present inventors realized. In that case, the system configuration (i.e., the configuration parameters used to determine the optimal numbers k and/or n) includes the number of CPU threads that can be assigned to the CPU cores 820c.

In practice, such CPU threads are then used to build S42 the tensors T₁-T_{L} and also execute S44 at least some of the tensor operations in parallel. For example, use can be made of the IBM z16 computerized system 800, i.e., a mainframe computer based on the so-called IBM Telum processor, where each processor chip consists of eight cores, as assumed in FIG. 10. More generally, though, any multicore system, or parallel processing system, may be used for the present purpose.

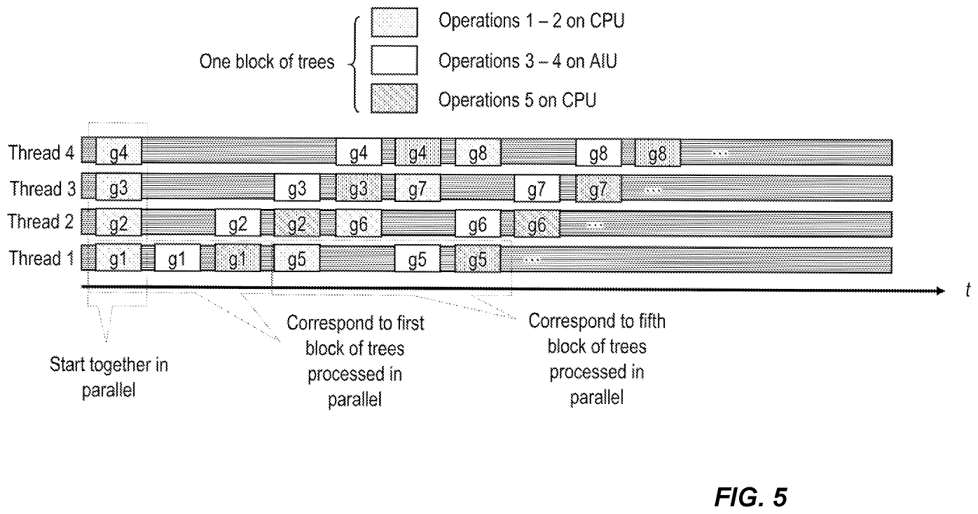

In embodiments, the calculations further benefit from hardware acceleration. Namely, the tensor operations include matrix operations, where at least some of these matrix operations can be offloaded to a hardware accelerator. More precisely, step S44 (tensor operations) can include the execution S441 of a part of the tensor operations through the CPU threads, while at least some of the matrix operations are offloaded S442 to a hardware accelerator 820a of the computerized system 800. In practice, steps S441 and S442 are interleaved, as illustrated in FIG. 5. In this example, tensor operations are started on each thread (i.e., thread 1, thread 2, thread 3, and thread 4), using a corresponding CPU core. Such operations correspond to jobs “g” in the rectangles that include a dotted pattern (“Operations 1-2”). Next, a matrix operation is offloaded to the hardware accelerator 820a, noted “AIU” in FIG. 5. Matrix operations correspond to jobs “g” in white rectangles (“Operations 3-4”). Finally, the residual tensor operations (corresponding to jobs “g” in rectangles including stripes, “Operation 5”) are resumed in the CPU cores, through corresponding threads.

In more detail, each job gi, (i.e., g1, 92, 93, g4, g5, g6, g7, and g8 in FIG. 5), corresponds to a corresponding block i of several trees that are processed in parallel, as explicitly indicated in respect of the first and fifth blocks in FIG. 5. As further seen in FIG. 5, jobs corresponding to the first four blocks of trees can be started in respective threads, in parallel, thanks to the four threads assumed to be available in this example. However, the offloaded matrix operations (“Operations 3-4”) are executed one after the other the hardware accelerator (AIU) in FIG. 5; a single AIU is assumed in this example. This which causes to accordingly shift the subsequent CPU operations (“Operation 5”). The various tensor operations shown in the rectangles are described below in detail.

In some embodiments, the hardware accelerator 820a forms part of the processing means of the computerized system 800, as assumed in FIG. 10. In some embodiments, the accelerator is an on-chip accelerator 820, i.e., a near-processing device. That is, the accelerator 820a is co-integrated with the conventional cores 820c. For example, a suitable hardware accelerator may be the so-called Integrated Accelerator for Artificial Intelligence Unit (AIU), implemented on each processing chip of the system 800 and shared among all CPU cores 820c of the processor set, as assumed in FIG. 10. In variants, the accelerator may be any in-memory compute (IMC) device, e.g., a device having a crossbar array structure, which is suited to accelerate matrix operations. The IMC device may for instance be co-integrated with the cores 820c, too. Alternatively, the accelerator is a separate device. This, however, results in longer data communication times compared with an integrated solution.

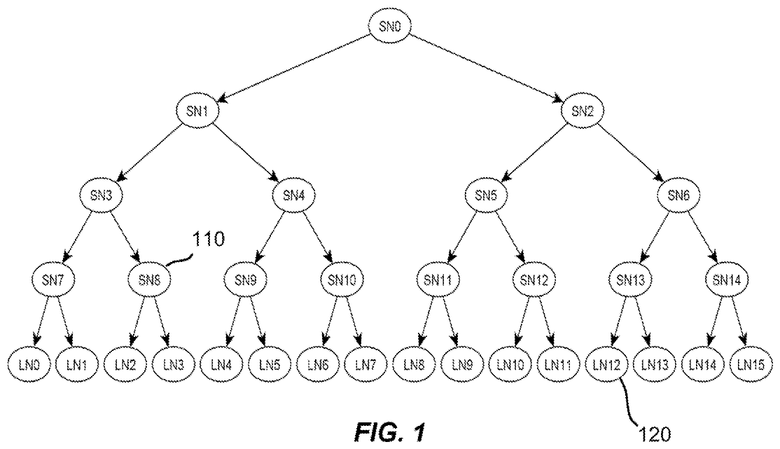

The following discusses the tensor operations in more details. Such tensor operations aim at executing one or more decision trees. Each decision tree has nodes 110, 120 extending from a root node to leaf nodes across a given number of levels, as illustrated in FIG. 1. Note, the N decision trees do not necessarily all have the same number of levels or the same number of nodes. The nodes of each tree include split nodes 110 (also known as internal nodes) and leaf nodes 120. The split nodes 110 are also denoted by references SN0 (corresponding to the root node) to SN14, while the leaf nodes 120 are denoted by references LN0 to LN15 in the example of FIG. 1.

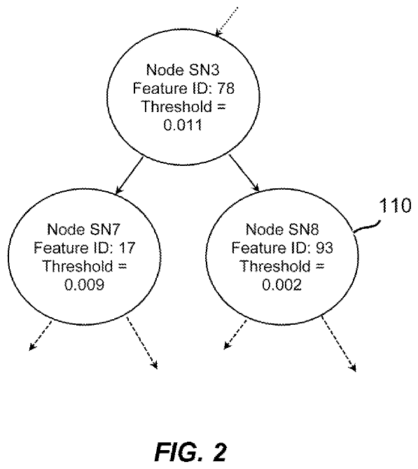

Each node has attributes, which include operands (as required to execute the nodes), feature identifiers (also called feature selectors), and thresholds (used for comparisons). More generally, the node attributes may include all arguments/parameters needed for evaluating the rules captured by the decision tree nodes. Each split node of a decision tree is labelled with a feature identifier and is associated with a threshold to perform an operation, whereby, e.g., a feature value corresponding to a feature identifier is compared to a threshold, as known per se. This is illustrated in FIG. 2, which depicts selected split nodes 110 of the tree shown in FIG. 1, together with respective feature identifier values (“feature ID”) and threshold values.

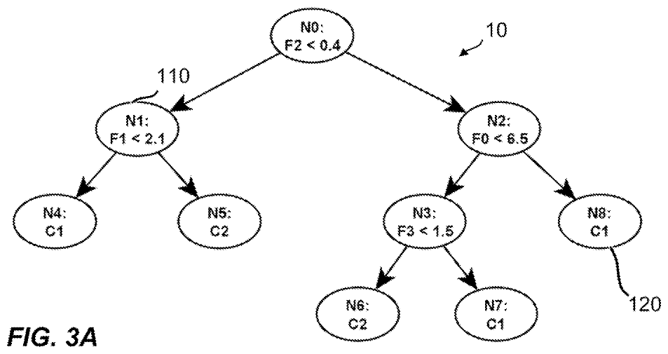

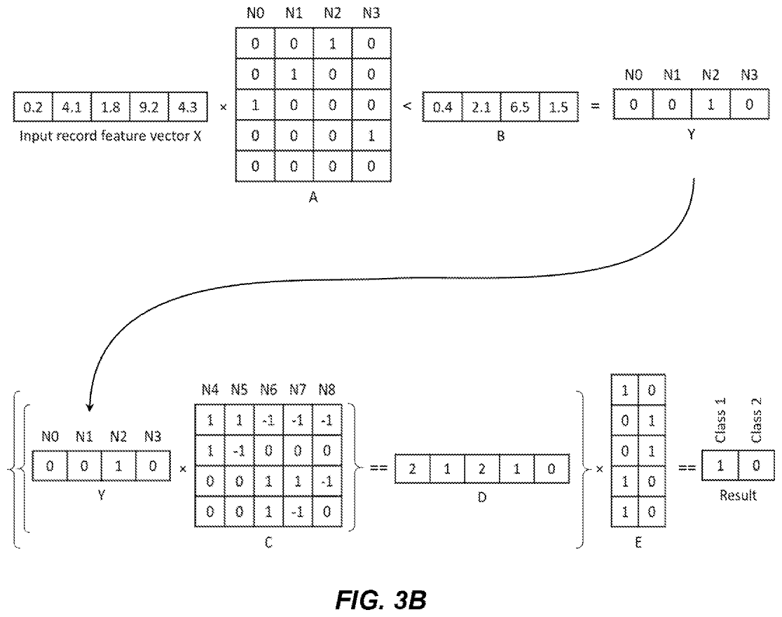

Consider now the case where a single input record is to be processed by a single decision tree 10, for simplicity, as illustrated in FIG. 3A. Following Nakandala et al., the required tensor operations can be decomposed into five operations for each input record and each decision tree. As seen in FIG. 3B, these operations make use of five matrices (A, B, C, D, and E) representing the structure of the decision tree. FIG. 3B shows how the decision tree 10 of FIG. 3A can be evaluated based on the five matrices for a given input record. The vector X captures feature values of this input record. The matrix A captures relationship between input features and split nodes (also called internal nodes) of the tree 10. The number of columns of matrix A corresponds to the number of split nodes of the tree 10. In the purposely simple example of FIG. 3A, the tree considered has only four split nodes N0, N1, N2, and N3, which result in four columns for matrix A. Vector B includes comparands which are set to the threshold values of the split nodes of the tree 10. Matrix C captures, for any leaf node and internal node pair, whether the internal node is a parent of that leaf node, and if so, whether it is in the left or right subtree. The number of columns of matrix C corresponds to the number of leaf nodes of the tree 10. In the example of FIG. 3A, the tree considered has five leaf nodes N4, N5, N6, N7, and N8, which result in five columns for matrix C. Vector D includes second comparands, each corresponding to the count of internal nodes in the path from a respective leaf node to the tree root, for which the internal node is the left child of its parent. Matrix E maps leaf nodes to class labels; the tree 10 is a classification tree in this example.

Using matrices as described above, the tensor operations can be decomposed into a sequence of five operations for each input record and each decision tree. Such operations start with a dot product of the row vector X by the matrix A, see FIG. 3B. This yields a first result (a row vector), which is subsequently compared (second operation) to the row vector B. This leads to a second result, captured by row vector Y. The third operation is a dot product of the row vector Y by matrix C. This yields a third result (another row vector), which is compared (fourth operation) with the row vector D. This provides a fourth result, i.e., a row vector Z, not explicitly shown in FIG. 3B. The last operation is a dot product of the row vector Z by the matrix E, which results in a fifth result (a row vector). The fifth result represents an inference result, corresponding to the outcome of executing the tree 10 with respect to the input record X.

Interestingly, the above decomposition can be generalized to sets involving any number of input records and any number of trees. Thus, in principle, the matrix operations can still be decomposed, for each of the K input records and each of the N decision trees, into five operations making use of five matrices. Now, at least one of the five operations includes a matrix-matrix multiplication (as discussed below in detail), such that this operation can advantageously be offloaded S442 to the hardware accelerator 820a.

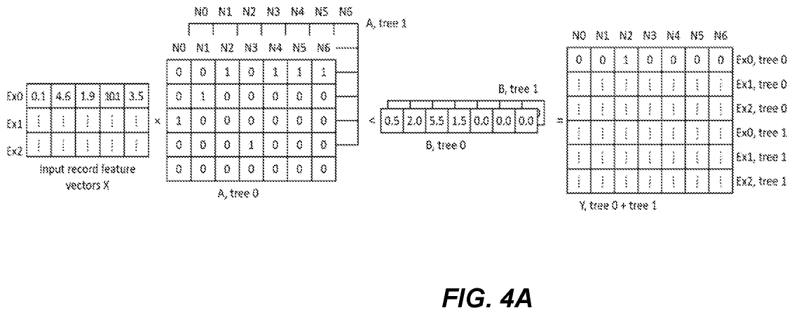

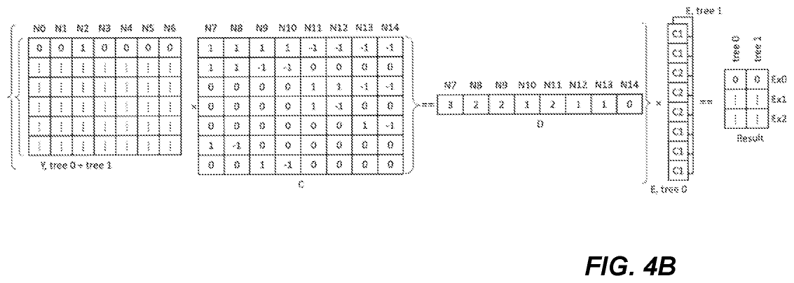

FIG. 4A and 4B illustrate one way of building adequate tensors, which amount to batching operations involved for each single input record and each single tree. This example assumes that only three input records and two decision trees are involved, for simplicity. That is, the row vector X now becomes a matrix X, which captures row vectors corresponding to respective input records (Ex0, Ex1, Ex2, etc., only the values of the first row are explicitly shown). The matrix A becomes a tensor, where each matrix corresponds to a respective tree (tree 0, tree 1). Thus, two vectors B are now needed, one for each tree, as shown in FIG. 4A. The processing of the matrices A and vectors B, which is shown in FIG. 4A, otherwise remains similar to that seen in FIG. 3B.

That is, operations start with dot products of matrices X and A, which yields first results (row vectors). The latter are subsequently compared (second operation) to the row vectors B. This leads to a second result, captured by a matrix Y aggregating row vectors. That is, the results are organized such that the number of rows in the matrix Y equals the product of the number of inputs and the number of trees that are processed in parallel (e.g., 2×3=6 rows in the example of FIG. 4A). Such operations can be performed thanks to CPU threads, as also illustrated in FIG. 5.

The third operation is a dot product of the matrix Y by matrix C, here corresponding to a fully balanced tree of depth 3, see FIG. 4B. A fully balanced tree is a perfect tree, where all leaves are on a same level, i.e., the lowest level. The matrices Y and C can thus be provided as input to the hardware accelerator. This yields a third result (another row vector), which is compared (fourth operation) with the row vector D. This provides a fourth result, i.e., a row vector Z, not explicitly shown in FIG. 4B. The last operation is a dot product of the row vector Z by the vectors E (one for each tree), which results in a fifth result, yielding a row vector for each input records (Ex0, Ex1, Ex2) or, conversely, one column vector for each tree (tree 0, tree 1). The fifth result represents an inference result, corresponding to the outcome of executing the two trees on the three input records. In practice, the hardware accelerator returns a matrix dot product, which is compared with the vector D. The last operation is processed on the CPU to provide the final prediction results.

As illustrated in FIG. 5, The first operation of “Operations 1-2” (rectangles with dots) corresponds to a dot product of matrix X and A. The second operation of “Operations 1-2” corresponds to the comparison of the outcome of the dot product with the row vectors B. The third and fourth operations of “Operations 3-4” (white rectangles) are operations that are offloaded to the AIU; they respectively correspond to a dot product of matrix Y by matrix C (third operation) and the subsequent comparison (fourth operation) with the row vector D. The fifth operation (rectangle with stripes) is the last operation, i.e., the dot product of the row vector Z by the vectors E.

Note, the above example assumes binary threes leading to binary classifications. More generally, though, several types of tensor operation decompositions can be contemplated, beyond the decomposition scheme proposed by Nakandala et al. (see the reference cited in the background section). Thu, other, albeit similar, tensor decompositions may be devised, as the skilled person may realize. For instance, the matrices may be adapted to non-binary trees and map more than two classes. The matrices may further be adapted to form predictions instead of classifications. Such tensor decompositions make it possible to process each input record through each of the decision trees, albeit in a parallel manner, using tensor operations involving node attributes of all of the decision trees involved, in their entirety. As one understands, this can remain computationally costly when large numbers of input records and decision trees are involved, hence the benefits of parallelization and acceleration.

In embodiments, the method only predicts S30 an optimal number of decision trees. That is, the optimal number k of the K input records is a predetermined number, whereby only the optimal number n of the N decision trees is determined at step S30, based on the specification identified and the system configuration. Note, the optimal number k may be provided as part of the request, i.e., in the specification. In all cases, the predetermined number k defines a batch size of batches of the inputs records to be processed S441, S442 in parallel by the computerized system 800. The batch size is the number of input records to be processed in batch, it corresponds to the number of rows in the matrix X. I.e., if the input matrix contains batches with multiple records, then all required operations can be performed using batched matrix operations.

The specification may contain additional parameters, such as a number of split nodes and a number of leaf nodes for each of the N decision trees. Such parameters will affect the dimensions of the tensors, too.

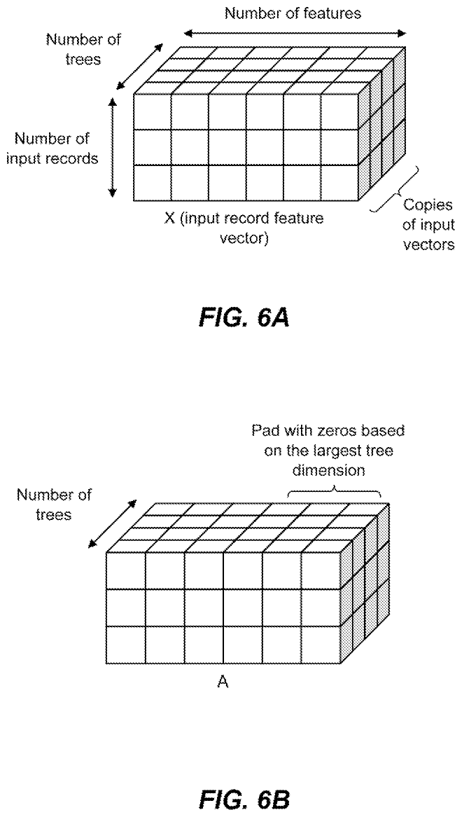

In the present context, the operations performed rely on tensors (or tensor subsets), which are captured by data structures, i.e., data that are populated in the main memory of the computer system 800 to perform the required operations. The tensors built may be regarded as 3D tensors, which can be zero-padded according to maximal dimensions of the decision trees involved, for practical reasons. I.e., the resulting tensor objects can be regarded as aggregating multiple 2D arrays, adequately zero-padded to compensate for the differences of dimensions of the decision trees. Example of 3D tensors are shown in FIGS. 6A and 6B. FIG. 6A shows a tensor aggregating features of input records. Each input record corresponds to a vector; the set of input records form a matrix, which is duplicated to match the number of trees involved. FIG. 6B shows another tensor aggregating matrices A obtained for the different trees involved. Depending on the implementation, however, the input matrix X may be defined as a 2D array, which is then broadcasted to perform the multiplication with a 3D tensor representation of matrix A, which captures information from all trees of the ensemble, as illustrated in FIG. 6B.

As depicted in FIG. 7, step S42 may lead to build several groups T, of input tensors X, and Aᵢ, where 1≤i≤L, which are processed at step S44. Such tensors are repeatedly processed in parallel, at steps S441, S442, by way of interleaved operations, as also seen in FIG. 5. Selecting the optimal number of input records and trees to be serviced in each matrix dot products on the hardware accelerator is beneficial as it allows to achieve maximum performance, e.g., by utilizing both CPU cores and an AIU accelerator in the example of FIG. 10. Optimal k and/or n parameters allow to parallelize the CPU tasks behind the single AIU resource shared by all the 8 cores in this example.

In embodiments, the optimal parameters k and/or n are determined S30 thanks to a lookup table, which maps parameter values of the system configuration and the specification onto optimal numbers k and/or n, corresponding to the optimal numbers of input records and/or decision trees to be processed in parallel. In variants, use can be made of machine learning inferences, using a model that is unrelated to the present decision trees, or an adjusted (fit) function, to achieve a similar result. However, it may be preferred to rely on a lookup table, in the interest of speed and accuracy. I.e., output values of a lookup table can correspond to absolute performance maxima, as opposed to statistical inferences obtained with by machine learning or analytical model.

The lookup table may initially be obtained S35 based on performance data collected for given ensemble models and system configurations. In variants, or in addition, the lookup table may be updated S70 based on performance data monitored for the computerized system 800, as assumed in FIG. 9. Performance data may initially be collected for given ensemble models and system configurations by running various experiments involving different numbers of threads and batch sizes using test data, if available. If no test data is available, the performance data can be collected S70 during normal system operation of the system 800 by slightly varying the value of n such that this value is further increased in case the experienced performance improves or is decreased otherwise. Additional methods can be contemplated, e.g., using interpolation or extrapolation techniques.

Once inference results have been obtained for all of the input records, a final result is formed at step S60. For example, ensemble inference results may be returned S60 for each input record, based on inference results obtained across the various decision trees. As noted earlier, the present approach can indeed be advantageously applied to ensemble models, including Gradient Boosting and Random Forests models. That is, the N decision trees involved may form part of an ensemble model. For example, each of the N decision trees may be a binary classification tree and each ensemble result obtained may be a binary classification result. Still, the present approach can be extended to support multi-class and regression tasks, too. Each of the N decision trees may for instance be a binary tree, but each ensemble result obtained may be a regression result. Where tree ensembles are involved, matrices similar to matrices A, B, C, D, and E can be created for each tree of the ensemble and batched to produce 3D tensors, as explained earlier. As the number of leaf nodes and internal nodes may vary from one tree to the other, the 3D tensor dimensions are determined by the maximum number of leaf nodes and internal nodes of all of the trees involved, while smaller matrix slices are padded with zeros. Thus, global tensors can be used, which can be zero-padded, where necessary.

Referring to FIGS. 8 and 10, another aspect of the disclosure concerns a computerized system 800 for performing machine learning inferences. Functional features of the computerized system 800 have already been described, if only implicitly, in reference to the present methods. The system 800 is thus only briefly described in the following. The system 800 may comprise one or more computerized units 801, e.g., each being a computer 801 such as shown in FIG. 8. For example, client requests may be received at one computer, while the corresponding tasks may be performed at one or more other computers.

In general, the system 800 is considered to include a receiving unit, which is configured to receive a request to perform machine learning inferences. Assuming that the system 800 primarily involves a single computer 801 (as in FIG. 8), then this computer 801 may for instance include a network module 815, which together with the communication fabric 811 and the processor set 810, makes up a receiving unit.

The system 800 further includes processing means 810, which are configured to perform steps as described earlier in reference to the present methods. Such steps revolve around processing requests, determining optimal parameters, and then accordingly performing machine learning inferences. Consistently with the present methods, each request received is processed to identify a specification, according to which machine learning inferences are to be performed on K input records, based on N decision trees, where K≥1 and N≥2. The optimal number k and/or the optimal number n are then determined based on the identified specification and the configuration of the processing means 810, where 1≤k≤K and 1≤n≤N. Finally, the machine learning inferences are performed by repeatedly executing parallel operations, whereby up to k input records and/or up to n decision trees are repeatedly processed in parallel by the processing means 810, to obtain inferences for each of the K input records based on the N decision trees.

As noted earlier, the processing means 810 may advantageously be configured to execute the parallel operations by first building tensors T₁-T_{L} corresponding to batched operands for the machine learning inferences, in accordance with the optimal parameters k and/or n, to subsequently execute tensor operations in accordance with the tensors T₁-T_{L} built.

In some embodiments, the processing means 810 includes a CPU 820u, which includes a number of CPU cores 820c, see FIG. 10. In that case, the system configuration as used at step S42 includes a number of CPU threads that can be assigned to the CPU cores 820c to build the tensors T₁-T_{L} and then execute at least some of the tensor operations in parallel, in operation. Moreover, the processing means 810 may further include a hardware accelerator 820a. In that case, the tensor operations are advantageously managed so as to cause to offload at least some of the matrix operations to the hardware accelerator 820a, in operation. As the, the CPU cores 820c and the hardware accelerator 820a may be co-integrated on a same chip; the hardware accelerator may be designed as a computational resource shared by all the CPU cores, to ease the offloading and orchestrations of operations, see FIG. 5.

Referring to FIG. 8, a final aspect concerns a computer program product for performing machine learning inferences. Basically, the computer program product comprises a computer readable storage medium 813 having program instructions 850 embodied therewith. The program instructions are executable by processing means 810 of a computerized system 800 as described above to cause the latter to perform steps as described earlier in reference to the present methods. In particular, such instructions may cause the computerized system 800 to take advantage of hardware accelerators to perform tensor operations, as discussed earlier.

The above embodiments have been succinctly described in reference to the accompanying drawings and may accommodate a number of variants. Several combinations of the above features may be contemplated. Examples are given in the next section.

An example flow is depicted in FIG. 9. Some of the references pertain to FIGS. 8 and 10. A request is received by the system 800 at step S10. The system 800 parses the request to identify S20 a specification contained in the request and read corresponding parameters, starting with the number K of input records and the number N of tree of the ensemble model. The latest system configuration is accessed at step S25. Next, the system 800 determine S30 optimal parameters (i.e., number k of input records and/or the optimal number n of decision trees to be processed in parallel), in accordance with parameters contained in the specification and the latest configuration. Use is made of a lookup table (e.g., implemented in software), which is initially obtained at step S35, based on performance data. Step S40 concerns decision tree inferences. Tensors are built at step S42, prior to accordingly performing S44 tensor operations. Part of the tensor operations are executed in parallel at step S441. Matrix dot products involved in the tensor operations are offloaded S442 to an on-chip accelerator. Steps S441 and S442 are interleaved and repeatedly performed, so as to walk all trees through all input records. Steps S42 and S441 are performed by the CPU cores 820c of the system 800, through CPU threads assigned to the CPU cores. Step S442 is performed by the accelerator 820a, which is share shared by all cores 820c. In practice, a CPU task S441 is followed by a task performed S442 by the accelerator, itself completed by further operations performed by the CPU cores, as depicted in FIG. 5. Once all tensors have been processed for each input records, ensemble results are obtained S60 for each input record. Statistics on the system performance may be updated S70, if necessary, which may further lead to update the lookup table. The system may them process S10 another request, and so on.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 800 contains an example of an environment for the execution of at least some of the computer code involved in performing the present methods, such as parallelization methods 850 as described herein. In addition to block 850, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 850, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located off chip. In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as the inventive methods). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid-state storage devices. Operating system 822 may take several forms, such as various known proprietary operating systems or open-source Portable Operating System Interface-type operating systems that employ a kernel. The code included in block 850 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801) and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as images. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

While the present disclosure has been described with reference to a limited number of embodiments, variants, and the accompanying drawings, it will be understood by those skilled in the art that various changes may be made, and equivalents may be substituted without departing from the scope of the present disclosure. In particular, a feature (device-like or method-like) recited in a given embodiment, variant or shown in a drawing may be combined with or replace another feature in another embodiment, variant or drawing, without departing from the scope of the present disclosure. Various combinations of the features described in respect of any of the above embodiments or variants may accordingly be contemplated, that remain within the scope of the appended claims. In addition, many minor modifications may be made to adapt a particular situation or material to the teachings of the present disclosure without departing from its scope. Therefore, it is intended that the present disclosure is not limited to the particular embodiments disclosed, but that the present disclosure will include all embodiments falling within the scope of the appended claims. In addition, many other variants than explicitly touched above can be contemplated.

Wat is claimed is:

1. A computer-implemented method of performing machine learning inferences, the computer-implemented method comprising:
receiving a request to perform machine learning inferences, the request including a specification, according to which the machine learning inferences are to be performed on K input records based on N decision trees, where K≥1 and N≥2;
determining, based on the specification and a configuration of a computerized system, an optimal number k of the K input records and an optimal number n of the N decision trees to be processed in parallel by this computerized system for performing the machine learning inferences, where 1≤k≤K and 1≤n≤N, and
performing the machine learning inferences by executing parallel operations, whereby up to k input records and up to n decision trees are repeatedly processed in parallel by the computerized system, to obtain inferences for each of the K input records based on the N decision trees.

2. The computer-implemented method of claim 1, further comprising:
building tensors corresponding to batched operands for the machine learning inferences in accordance with the optimal number k and the optimal number n of the N decision trees, and executing the parallel operations comprises executing tensor operations in parallel in accordance with the tensors built.

3. The computer-implemented method of claim 2, wherein:
the computerized system includes a central processing unit (CPU) which includes a number of CPU cores, and
the configuration includes a number of CPU threads that can be assigned to the CPU cores to build the tensors and at execute at least some of the tensor operations in parallel.

4. The computer-implemented method of claim 3, wherein:
the tensor operations comprises matrix operations, and
executing the tensor operations comprises executing part of the tensor operations through the CPU threads and offloading at least some of the matrix operations to a hardware accelerator of the computerized system, in an interleaved manner.

5. The computer-implemented method of claim 4, wherein:
the matrix operations can be decomposed, for each of the K input records and each of the N decision trees, into five operations making use of five matrices, and
one of the five operations includes a matrix-matrix multiplication, which is offloaded to the hardware accelerator.

6. The computer-implemented method of claim 1, wherein the optimal number k of the K input records is a predetermined number, whereby only the optimal number n of the N decision trees is determined based on the specification and the configuration.

7. The computer-implemented method of claim 6, wherein the specification further includes the optimal number k.

8. The computer-implemented method of claim 1, wherein the specification further includes a number of split nodes and a number of leaf nodes for each tree of the N decision trees.

9. The computer-implemented method of claim 1, wherein each tree of the N decision trees is a fully balanced tree.

10. The computer-implemented method of claim 1, wherein each tree of the N decision trees is a binary decision tree.

11. The computer-implemented method of claim 1, wherein the optimal number k and the optimal number n are determined based on a lookup table, which maps parameter values of the configuration and the specification onto optimal numbers of input records and optimal numbers of decision trees to be processed in parallel.

12. The computer-implemented method of claim 11, further comprising obtaining and updating the lookup table based on performance data of the computerized system.

13. The computer-implemented method of claim 1, wherein:
the N decision trees form an ensemble model, and
the machine learning inferences are performed to obtain an ensemble result for each of the K input records.

14. The computer-implemented method of claim 1, wherein each of the N decision trees is a binary tree and each ensemble result obtained is one of a binary classification result and a regression result.

15. A system for performing machine learning inferences, the system comprising:
a receiving unit configured to receive a request to perform machine learning inferences, and
processing means, which are configured to:
process the received request to identify a specification, according to which the machine learning inferences are to be performed on K input records, based on N decision trees, where K≥1 and N≥2;
determine, based on the identified specification and a configuration of the processing means, an optimal number k of the K input records and an optimal number n of the N decision trees to be processed in parallel for performing the machine learning inferences, where 1≤k≤K and 1≤n≤N, and
perform the machine learning inferences by executing parallel operations, whereby up to k input records and up to n decision trees are repeatedly processed in parallel by the processing means, to obtain inferences for each of the K input records based on the N decision trees.

16. The system of claim 15, wherein the processing means are configured to execute the parallel operations by:
building tensors corresponding to batched operands for the machine learning inferences in accordance with the optimal number k and the optimal number n of the N decision trees, and executing tensor operations in accordance with the tensors built.

17. The system according to claim 16, wherein:
the processing means includes a central processing unit, or CPU, which includes a number of CPU cores, and
the configuration includes a number of CPU threads that are assignable to the number of CPU cores to build the tensors and execute at least some of the tensor operations in parallel, in operation.

18. The system according to claim 17, wherein:
the tensor operations comprise matrix operations, in operation, and
the processing means further includes a hardware accelerator, whereby executing the tensor operations comprises offloading at least some of the matrix operations to the hardware accelerator, in operation.

19. The system according to claim 18, wherein the CPU cores and the hardware accelerator are co-integrated on a same chip and the hardware accelerator is a resource shared by all the CPU cores.

20. A computer program product for performing machine learning inferences, the computer program product comprising a computer readable storage medium having program instructions embodied therewith, the program instructions executable by processing means of a system to cause the system to:
process a received request to perform machine learning inferences, in order to identify a specification, according to which the machine learning inferences are to be performed on K input records, based on N decision trees, where K≥1 and N≥2;
determine, based on the specification and a configuration of the processing means, an optimal number k of the K input records and an optimal number n of the N decision trees to be processed in parallel by the processing means for performing the machine learning inferences, where 1≤k≤K and 1≤n≤N, and
perform the machine learning inferences by executing parallel operations, whereby up to k input records and up to n decision trees are repeatedly processed in parallel by the system, to obtain inferences for each of the K input records based on the N decision trees.
